(19) United States
(12) Patent Application Publication
(10) Pub. No.: US 2008/0147571 A1
(43) Pub. Date: Jun. 19, 2008

(54) System and method for analyzing machine customization costs

(75) Inventors: Jonny Ray Greiner, Dunlap, IL (US); Giles Kent Sorrells, Metamora, IL (US); Richard Lee Gordon, East Peoria, IL (US); Anthony James Grichnik, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,236

(22) Filed: Sep. 29, 2006

(51) Int. Cl. G06F 17/00; G06F 19/00

(52) U.S. Cl. 705/400; 700/108

(57) ABSTRACT

A method for analyzing machine customization costs includes receiving one or more specifications associated with a machine and identifying a machine type based on the one or more specifications. Prognostic data associated with the machine type is analyzed based on the specifications, and costs associated with operating a stock machine corresponding to the machine type is estimated based on the prognostic data analysis. A machine customization package may be assembled based on the specifications and costs associated with operating a customized machine associated with the machine customization package may be analyzed. A cost analysis report that compares estimated costs associated with operating the stock machine with estimated costs associated with operating the customized machine is provided.

### TECHNICAL FIELD

The present disclosure relates generally to cost analysis systems and, more particularly, to systems and methods for analyzing machine customization costs.

### BACKGROUND

In many of today's work environments, particularly those associated with industries such as mining, construction, energy exploration, transportation, and farming, several machines may cooperate to perform a variety of tasks. In many cases, these machines may be operated under abnormal conditions for prolonged periods of time, potentially increasing the service requirements of the machine. As the severity of the conditions and the length of time that the machine operates under these conditions increase, the additional service requirements may make operation of the machine under these conditions cost prohibitive.

In an effort to limit costs associated with prolonged machine operation under abnormal conditions, customers may opt to customize the machine to accommodate a particular operational environment. However, these customizations, in addition to increasing the cost of a particular machine, may necessitate alternative service requirements. In some cases, customers that opt to have a stock machine customized to conform to a particular operating environment may be unaware that the stock machine, without customization, although requiring more frequent service, may be more cost effective than the customization and subsequent maintenance associated with modifying the stock machine to accommodate the environment. Thus, in order to identify a cost-effective equipment solution for a particular operational environment, a method for analyzing costs associated with machine customization, based on customer-defined environmental specifications, may be required.

One method for customizing operations associated with existing equipment based on certain task specifications is described in U.S. Patent Application Publication No. 2004/0267395 (“the '395 publication”) to Discenzo et al. The '395 publication describes a system for optimizing machine operation and selection based on a desired business objective. This optimization scheme is based on status data gathered from components of the machine and expected or predicted future demand on the machine. This data may predict future states of the machine and control the system so as to avoid potential “undesirable” future states. Periodically, the desired business objective is evaluated with respect to the component status data to adjust operations of the components to converge with the business objective. The optimization system may also be used in the component selection process, whereby desired business objectives drive the selection of components for a particular machine.

Although the system of the '395 publication may aid in the selection and control of machine components, so as to conform to a desired business objective, it does not, however, provide a user with cost comparisons associated with multiple machine customization options. For example, while the system of the '395 publication may, in some cases, compile a list of machine components that meet a particular objective, it does not enable customers to analyze cost differences between a stock machine and a customized machine, based on a particular operational environment associated with the machine. As a result, the system of the '395 publication may select certain components for a machine that, while conforming more closely to a particular operational objective, may increase the cost of the machine substantially, thereby reducing the overall profit potential of the machine.

Additionally, because the system of the '395 publication does not provide information that enables customers to analyze the present and future costs associated with operating both stock and customized machines for a particular work environment, organizations that rely on making machine selection decisions based on cost consideration may become inefficient. For instance, the system of the '395 publication may configure a particular machine based on conformance to certain performance specifications, without regard for costs associated with the configuration, thereby disregarding alternatives that may perform adequately at a lower cost. As a result, organizations that employ the system of the '395 publication may unnecessarily invest in expensive, specialized equipment configurations, thereby potentially reducing machine and/or work site profitability.

The presently disclosed method and system for analyzing machine customization costs are directed toward overcoming one or more of the problems set forth above.

### SUMMARY OF THE INVENTION

In accordance with one aspect, the present disclosure is directed toward a method for analyzing machine customization costs. The method may include receiving one or more specifications associated with a machine and identifying a machine type based on the one or more specifications. Prognostic data associated with the machine type may be analyzed based on the specifications, and costs associated with operating a stock machine corresponding to the machine type may be estimated based on the analysis. A machine customization package may be assembled based on the specifications, and costs associated with operating a customized machine associated with the machine customization package may be predicted. Finally, a cost analysis report, which compares estimated costs associated with operating the stock machine with estimated costs associated with operating the customized machine, may be provided.

According to another aspect, the present disclosure is directed toward a method for analyzing machine customization costs. The method may include receiving one or more specifications associated with a machine and analyzing prognostic data associated with the machine based on the specifications. Costs associated with operating a stock machine corresponding to the machine type may be estimated based on the analysis. Additionally, a machine customization package may be assembled based on the specifications and costs associated with operating a customized machine associated with the machine customization package may be estimated. If the estimated stock operating costs exceed the estimated customized operating costs the customized machine may be selected. Alternatively, if the estimated stock operating costs do not exceed the estimated customized operating costs the stock machine may be selected.

In accordance with yet another aspect, the present disclosure is directed toward a system for evaluating machine customization costs. The system may include a data collector for collecting health data associated with a machine and a prognostic analysis system, communicatively coupled to the data collector. The prognostic system may configured to receive the health data from the data collector and derive prognostic data for a plurality of machine types and components associated therewith, based on the health data. The evaluation system may also include a machine customization system in communication with the data collector. The machine customization system may be configured to receive one or more specifications associated with a machine and identify a machine type based on the one or more specifications. Prognostic data associated with the machine type may be analyzed based on the specifications and costs associated with operating a stock machine corresponding to the machine type may be estimated based on the analysis. A machine customization package may be assembled based on the specifications and costs associated with operating a customized machine associated with the machine customization package may be predicted. Finally, the machine customization system may be configured to provide a cost analysis report, which compares estimated costs associated with operating the stock machine with estimated costs associated with operating the customized machine.

### BRIEF DESCRIPTION OF THE DRAWINGS

FIG. 1 provides a diagrammatic illustration of a project environment according to an exemplary disclosed embodiment;

FIG. 2 provides a schematic illustration of the exemplary disclosed project environment of FIG. 1;

FIG. 3 provides a schematic illustration of a machine customization system in accordance with certain disclosed embodiments; and

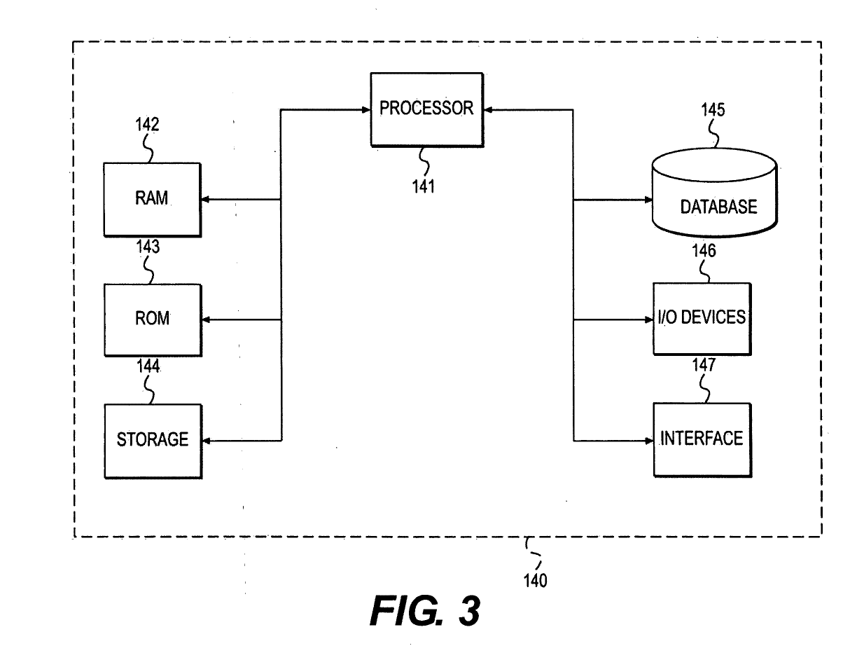

FIG. 4 provides a flowchart depicting an machine customization cost evaluation process associated with the disclosed embodiments.

### DETAILED DESCRIPTION

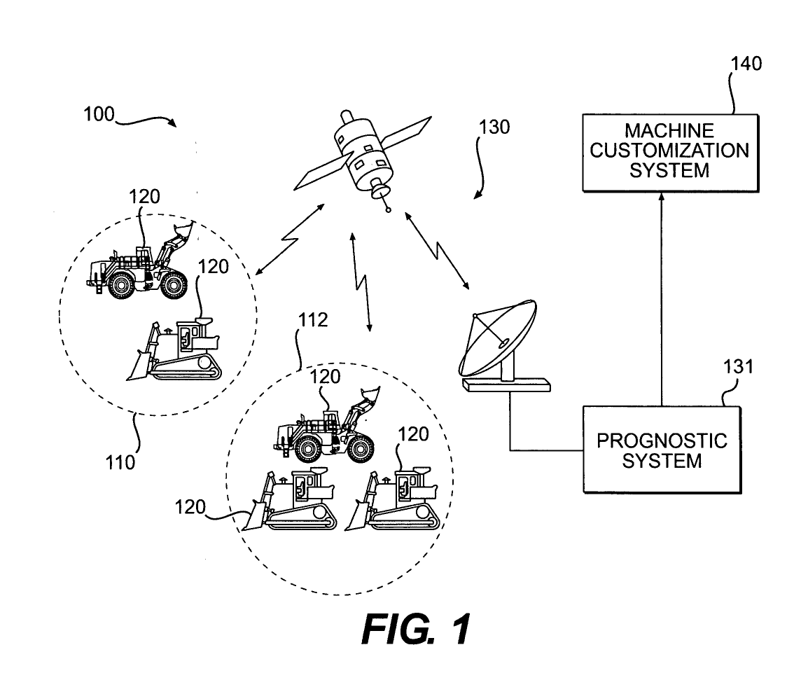

FIG. 1 illustrates an exemplary project environment 100 consistent with certain disclosed embodiments. Project environment 100 may include components that perform individual tasks that contribute to a machine environment task, such as mining, construction, transportation, agriculture, manufacturing, or any other type of task associated with other types of industries. For example, project environment 100 may include one or more machines 120 coupled to a prognostic system 131 via a communication network 130. Project environment 100 may be configured to monitor, collect, and filter information associated with an operation of one or more machines 120 and distribute the information to one or more back-end systems, such as machine customization system 140. It is contemplated that additional and/or different components than those listed above may be included in project environment 100.

Machines 120 may each be a fixed or mobile machine configured to perform an operation associated with project environment 100. Thus, machine, as the term is used herein, refers to a fixed or mobile machine that performs some type of operation associated with a particular industry, such as mining, construction, farming, etc. and operates between or within project environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A machine may be driven by a combustion engine or an electric motor. The types of machines listed above are exemplary and not intended to be limiting. It is contemplated that project environment 100 may implement any type of machine. Accordingly, although FIG. 1 illustrates machines 120 as particular types of machines, each machine 120 may be any type of machine operable to perform a particular function within project environment 100. Furthermore, it is contemplated that machines 120 may include a first set of machines 110 and a second set of machines 112 for associating the operations of particular machines to groups of machines. Furthermore, it is also contemplated that first and second sets of machines may be located in separate work sites located remotely from each other, and with prognostic system 131.

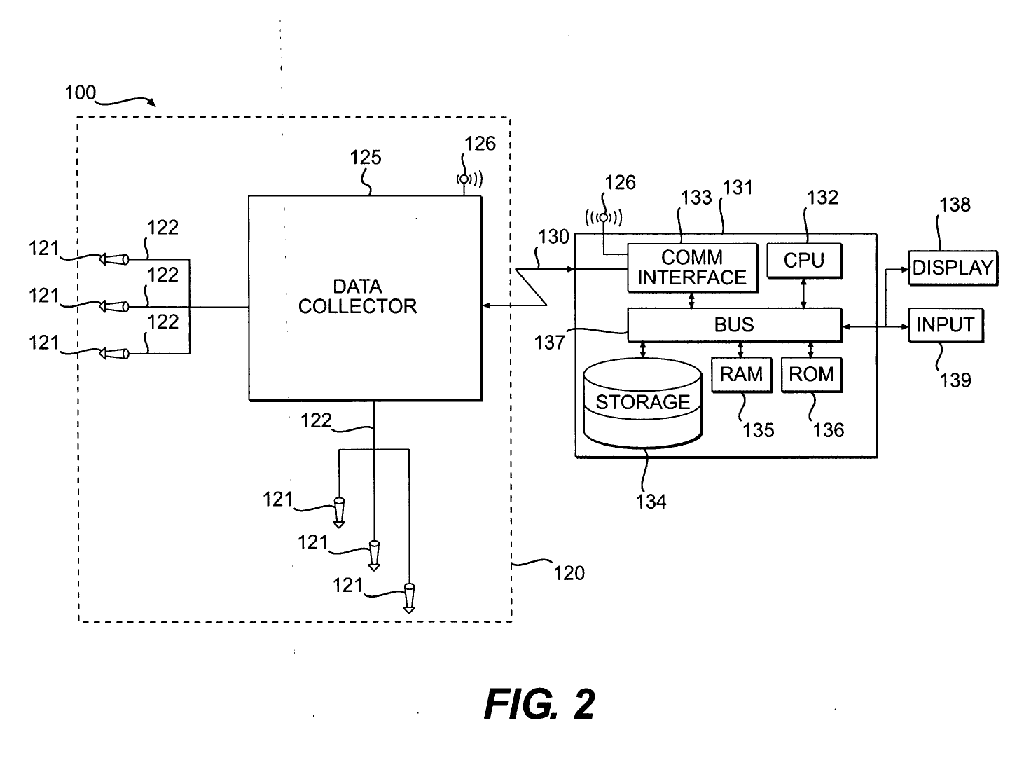

In one embodiment, each machine 120 may include on-board data collection and communication equipment to monitor, collect, and/or transmit information associated with an operation of one or more components of machine 120. As shown in FIG. 2, machine 120 may include, among other things, one or more monitoring devices 121, such as sensors coupled to one or more data collectors 125 via communication lines 122, one or more transceiver devices 126, and/or any other such components for monitoring, collecting, and communicating information associated with the operation of machine 120. Each machine 120 may also be configured to receive information from off-board systems, such as a prognostic system 131, network server (not shown), or any other back-end communication system. The components described above are exemplary and not intended to be limiting. Accordingly, the disclosed embodiments contemplate each machine 120 including additional and/or different components than those listed above.

Monitoring devices 121 may include any type of sensor or sensor array and may be associated with one or more components of machine 120 such as, for example, a power source, a torque converter, a transmission, a work implement, a fluid supply, a traction device, and/or other components and subsystems of machine 120. Monitoring devices 121 may be configured to automatically gather operation associated with one or more components and/or subsystems of machine 120. Operation data, as the term is used herein may include, for example, implement, engine, and/or machine speed and/or location; fluid pressure, flow rate, temperature, contamination level, and or viscosity of a fluid; electric current and/or voltage levels; fluids (i.e., fuel, oil, etc.) consumption rates; loading levels (i.e., payload value, percent of maximum payload limit, payload history, payload distribution, etc.); transmission output ratio, slip, etc.; grade; traction data; scheduled or performed maintenance and/or repair operations; and any other suitable operation data. It is contemplated that sensing devices may be associated with additional, fewer, and/or different components and/or subsystems associated with machine 120 than those listed above.

Data collector 125 may be operable to collect operational information associated with machine 120 from monitoring devices 121 and derive health information associated with one or more components based on the operation data. For example, data collector 125 may receive operation data from a plurality of components, compile the received data, and analyze the data to determine the health of the component. According to one embodiment, the determination of component health may include an exception-based determination system, whereby a “normal” status is applied, unless an operational aspect associated with the operation data for the component is inconsistent with a predetermined benchmark level. Depending upon the particular operational aspect and the severity of the inconsistency, various stages of health status (or alerts) may be determined and assigned to a component or system. Data collector 125 may distribute the operation, health, and status information to prognostic system 131 via communication network 130.

Communication network 130 may include any network that provides two-way communication between each machine 120 and an off-board system, such as prognostic system 131. For example, communication network 130 may communicatively couple machines 120 to prognostic system 131 across a wireless networking platform such as, for example, a satellite communication system. Alternatively and/or additionally, communication network 130 may include one or more other broadband communication platforms appropriate for communicatively coupling one or more machines 120 to prognostic system 131 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite-based wireless communication network, it is contemplated that communication network 130 may include wireline networks such as, for example, Ethernet, fiber optic, waveguide, or any other type of wired communication network.

Prognostic system 131 may include any computing system configured to receive, analyze, and distribute operational data received from one or more machines 120 via communication network 130. Additionally, prognostic system 131 may be configured to store historic operation and health information collected from previous operations of machines within project environment 100.

In one embodiment, prognostic system 131 may include hardware and/or software components that perform processes consistent with certain disclosed embodiments. For example, as illustrated in FIG. 2, prognostic system 131 may include one or more transceiver devices 126, a central processor unit (CPU) 132, a communication interface 133, one or more computer-readable memory devices, including storage device 134, a random access memory (RAM) module 135, and a read-only memory (ROM) module 136, a display device 138, and/or an input device 139. The components described above are exemplary and not intended to be limiting. Furthermore, it is contemplated that prognostic system 131 may include alternative and/or additional components than those listed such as, for example, one or more software programs including instructions for executing process steps when executed by CPU 132.

CPU 132 may be one or more processors that execute instructions and process data to perform one or more processes consistent with certain disclosed embodiments. For instance, CPU 132 may execute software that enables prognostic system 131 to request and/or receive operation data from data collector 125 of machines 120. CPU 132 may also execute software that stores collected operation data in storage device 134. In addition, CPU 132 may execute software that enables prognostic system 131 to analyze operation data collected from one or more machines 120, modify one or more project specifications of the project environment 100, and/or provide customized productivity reports, including recommendations for modifications to project specifications and/or operational instructions for executing the project and or machines associated therewith. A project specification may include one or more characteristics associated with the execution of a machine project such as, for example, a project schedule for completion of the machine project, a productivity schedule for each respective machine operating in project environment 100, a project productivity rate (e.g., percentage of project completed per month), a project budget, a productivity quota for machine 120, maintenance schedules, hours of operation for the machine and/or job site, an assignment for a particular machine, a job site inventory, and any other type of characteristic associated with project management. Furthermore, a project specification may include a guideline that, when used as a project benchmark, may assist in the appropriate execution of a project performed within project environment 100. These benchmarks may include incremental completion milestones, budget forecasts, and any other type of performance and/or operation benchmark.

CPU 132 may be connected to a common information bus 146 that may be configured to provide a communication medium between one or more components associated with prognostic system 131. For example, common information bus 137 may include one or more components for communicating information to a plurality of devices. CPU 132 may execute sequences of computer program instructions stored in computer-readable medium devices such as, for example, a storage device 134, RAM 135, and/or ROM 136 to perform methods consistent with certain disclosed embodiments, as will be described below.

Communication interface 133 may include one or more elements configured for communicating data between prognostic system 131 and one or more data collectors 125 via transceiver device 126 over communication network 130. For example, communication interface 133 may include one or more modulators, demodulators, multiplexers, demultiplexers, network communication devices, wireless devices, antennas, modems, and any other type of device configured to provide data communication between prognostic system 131 and remote systems or components.

One or more computer-readable medium devices may include one or more storage devices 134, a RAM 135, ROM 136, and/or any other magnetic, electronic, or optical data computer-readable medium devices configured to store information, instructions, and/or program code used by CPU 132 of prognostic system 131. Storage devices 134 may include magnetic hard-drives, optical disc drives, floppy drives, or any other such information storing device. A random access memory (RAM) device 135 may include any dynamic storage device for storing information and instructions by CPU 132. RAM 135 also may be used for storing temporary variables or other intermediate information during execution of instructions to be executed by CPU 132. During operation, some or all portions of an operating system (not shown) may be loaded into RAM 135. In addition, a read only memory (ROM) device 136 may include any static storage device for storing information and instructions by CPU 132.

Prognostic system 131 may be coupled to on-board data collection and communication equipment to monitor, collect, and/or transmit information associated with an operation of one or more components of machine 120. In one embodiment, prognostic system 131 may be coupled to one or more data collectors 125 on respective machines 120 via transceiver device 126 to collect operation and/or productivity data from one or more monitoring devices 121 and/or any other components for monitoring, collecting, and communicating information associated with the operation of a respective machine 120. Prognostic system 131 may also be configured to transmit information to machine 120 via communication network 130.

Prognostic system 131 may also include other components that perform functions consistent with certain disclosed embodiments. For instance, prognostic system 131 may include a memory device configured to store, among other things, one or more software applications including, for example, a database program, a graphical user interface, data acquisition and analysis software, or any other appropriate software applications for operating and/or monitoring project environment 100.

Prognostic system 131 may be configured to analyze the operation data associated with a particular component to derive health data associated with the component. The health data may be derived by comparing the operation data to one or more predetermined threshold levels associated with particular component corresponding to the appropriate operational level associated with the component. For instance, prognostic system 131 may compare a temperature measurement associated with a motor with a temperature threshold or range associated with an acceptable operating temperature for the motor. Prognostic system 131 may determine the overall health of the motor based on the comparison.

In addition to deriving health data associated with a component, prognostic system 131 may analyze the health data with respect to historical health data associated with the component for the particular machine type. Based on the health data analysis, prognostic system 131 may predict certain lifecycle data associated with the component. For example, prognostic system 131 may predict a maintenance schedule associated with a component based on the current health data and historic maintenance requirements of the component. Alternatively, prognostic system 131 may estimate and/or update the expected lifespan of the system and/or predict a future failure date based on the current health and historical component data.

In one exemplary embodiment, prognostic system 131 may include software configured to derive prognostic data (e.g., health data, lifecycle data, etc.) through comparisons of current operation and/or health data that exhibits similar trends as historic operation and/or health data associated with the component or component type. For example, prognostic system 131 may identify a present trend in temperature data associated with a motor (such as abnormal elevation of core or winding temperature). Prognostic system 131 may compare the present temperature data with historic temperature data associated with previous operations of the same type of motor. Prognostic system 131 may identify a trend in the historical temperature data corresponding to the trend in the present temperature data. Once a similar trend in the historic data has been identified, the prognostic system software may use maintenance activity and lifecycle data associated with the historical operation data to derive service requirements and predict potential lifecycle information for present operations of the component. Alternatively and/or additionally, it is contemplated that prognostic system software may predict future maintenance activities and other lifecycle data (such as future failure date(s)) using various types of “expected” lifecycle data such as, for example, computer generated data derived from component simulations.

Machine customization system 140 may include one or more computer systems configured to collect, monitor, analyze, evaluate, store, record, and transmit operation data associated with machine 110. Machine customization system 140 may be associated with one or more business entities associated with machine 110 such as a manufacturer, an owner, a project manager, a dispatcher, a maintenance facility, a performance evaluator, or any other entity that generates, maintains, sends, and/or receives information associated with machine 110. Although machine customization system 140 is illustrated as a laptop computer, it is contemplated that machine customization system 140 may include any type of computer system such as, for example, a desktop workstation, a handheld device, a personal data assistant, a mainframe, or any other suitable computer system.

As explained, machine customization system 140 may include one or more computer systems and/or other components for executing software programs. For example, as illustrated in FIG. 2, risk assessment system may include a processor (i.e., CPU) 141, a random access memory (RAM) 142, a read-only memory (ROM) 143, a storage 144, a database 145, one or more input/output (I/O) devices 146, and an interface 147. It is contemplated that machine customization system 140 may include additional, fewer, and/or different components than those listed above. It is understood that the type and number of listed devices are exemplary only and not intended to be limiting.

CPU 141 may include one or more processors that can execute instructions and process data to perform one or more functions associated with machine customization system 140. For instance, CPU 141 may execute software that enables machine customization system 140 to request and/or receive operation data from one or more sensing devices 121. CPU 141 may also execute software that enables machine customization system 140 to further analyze one or more diagnostic and/or prognostic alerts to determine a potential preventative maintenance plan.

CPU 141 may also execute software that receives machine specifications associated with a potential project environment or a desired machine function and identifies, based on the specifications, one or more stock or customized machines that meet the customer-supplied specifications. CPU 141 may receive these specifications in electronic format via a storage device. Alternatively, CPU 141 may receive the specifications in response to particular prompts for information by a graphical user interface associated with machine customization system 140.

Storage 144 may include a mass media device operable to store any type of information needed by CPU 141 to perform processes associated with operational monitoring system 140. Storage 144 may include one or more magnetic or optical disk devices, such as hard drives, CD-ROMs, DVD-ROMs, or any other type of mass media device.

Database 145 may include one or more memory devices that store, organize, sort, filter, and/or arrange data used by machine customization system 140 and/or CPU 141. For example, database 145 may store historical performance data associated with a particular machine 110. Database 145 may also store benchmark and/or other data values associated with machine performance. Database 145 may also store operational parameters for each component or system of components associated with machine 110, including normal operating ranges for the components, threshold levels, etc.

Input/Output (I/O) devices 146 may include one or more components configured to interface with a user associated with machine environment 100. For example, input/output devices 146 may include a console with integrated keyboard and mouse to allow a user of machine customization system 140 (e.g., customer, client, project manager, etc.) to input one or more benchmark values, modify one or more operational specifications, and/or machine operation data. Machine customization system 140 may store the performance, productivity, and/or operation data in storage 144 for future analysis and/or modification.

Interface 147 may include one or more elements configured for communicating data between machine customization system 140 and prognostic system 131. For example, interface 147 may include one or more modulators, demodulators, multiplexers, demultiplexers, network communication devices, wireless devices, antennas, modems, and any other type of device configured to provide data communication between machine customization system 140 and remote systems or components.

Additionally, interface 147 may include hardware and/or software components that allow a user to access information stored in machine customization system 140 and/or machine customization system 140. For example, machine customization system 140 may include a data access interface that includes a graphical user interface (GUI) that allows users to access, configure, store, and/or download information to external systems, such as computers, PDAs, diagnostic tools, or any other type of external data device. Moreover, interface 147 may allow a user to access and/or modify information, such as operational parameters, operating ranges, and/or threshold levels associated with one or more component configurations stored in database 145. Alternatively and/or additionally, interface 147 may enable customers to download reports, recommendations, and/or analysis data generated by machine customization system 140 and/or prognostic system 131.

As explained, machine customization system 140 may include one or more software programs that, when executed, provide a system for identifying a particular stock machine based on task information, project parameters, environmental aspects, desired performance requirements, or other specifications provided by a user. The software may enable machine customization system 140 to perform cost analysis associated with operating the stock machine versus operating a customized or specialized machine adapted to reduce the maintenance frequency of the machine. Operation of machine customization system 140 and software associated therewith is described in greater detail below.

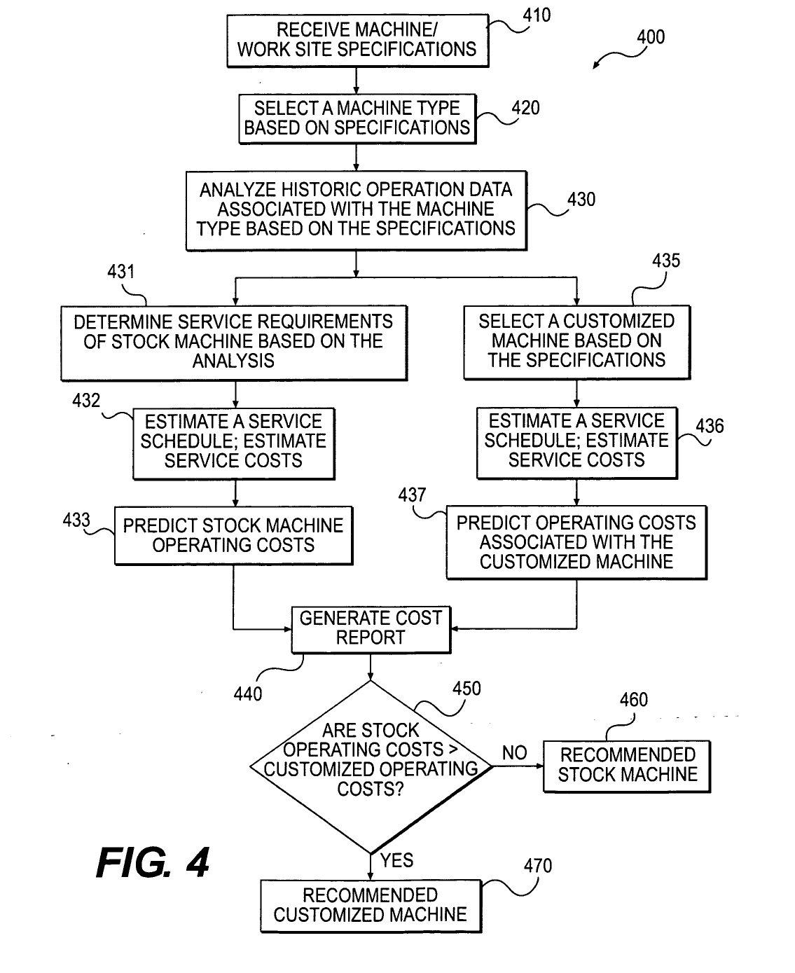

Processes and methods consistent with the disclosed embodiments provide organizations and users with a system for quantifying costs and benefits associated with upgrading or customizing a machine and comparing these costs with costs associated with operating and maintaining a stock (i.e., non-upgraded) machine. FIG. 4 provides a flowchart 400 depicting an exemplary disclosed method for analyzing and evaluating machine customization costs. As illustrated in FIG. 4, machine customization system 140 may receive machine and/or work site specifications from a user of the system (e.g., customer, machine dealer, project manager, machine leasing agent, etc.) (Step 410). As explained, this information may be received from a user via a graphical user interface (GUI) or other any other type of system that allows a user to passively, actively, and/or interactively input the specifications into machine customization system 140. According to one embodiment, machine customization system 140 may include a kiosk or workstation at a dealer location that provides interactive machine selection software that prompts customers to respond to questions related to, among other things, desired machine performance, operating conditions, environmental factors, etc. The responses may be collected by machine customization system 140 and stored as specifications. It is contemplated that machine customization may perform additional steps in association with the customer input such as, for example, assigning a customer ID or job number to the user corresponding to the particular responses provided. Accordingly, the steps provided above are exemplary only and not intended to be limiting.

Once the specifications have been received, machine customization system 140 may select or identify a machine type based on the specifications (Step 420). As part of the selection process, machine customization system 140 may analyze the user-input specifications and select, based on the analysis, a machine types that most closely conforms to the specifications. For example, machine customization system 140 may receive specifications for a hauler including, among other things, payload capacity, terrain, soil conditions (hard, sandy, wet, etc.), slope or angle of inclination, temperature, and air quality (e.g., salty, dusty, etc.). Based on the specifications, machine customization system 140 may identify a particular hauler meeting the payload requirements for the particular machine.

Upon identifying the machine type, machine customization system 140 may analyze historic operation data associated with the machine (Step 430). For example, machine customization system 140 may access data stored in prognostic system 131 associated with previous operations of the selected hauler. Machine customization system 140 may analyze historic data associated with a stock machine, that includes only standard components, as well as historic data associated with various customized or specialized machines, that include upgraded, specialized, or modified components. Where possible, machine customization system 140 may analyze historic data associated with similar environmental characteristics as those input by the user. For example, if a user specifies that a machine is operating on a particular angle of inclination for prolonged periods of time, machine customization system 140 analyze only historic data associated with machines operating on inclines for prolonged periods. Alternatively and/or additionally, machine customization system may analyze all historical operation data available, while weighting particular data conforming to the specifications input by the user. Thus, rather than ignoring certain historical operation data completely simply because it may not conform to one or more specifications, machine customization system 140 may allow for certain historical data to more heavily affect the analysis depending on how closely the particular historical operations conform to the specifications.

Once the historical operation data has been analyzed machine customization system 140 may determine the service requirements of the stock machine, based on the analysis (Step 431). Service requirements, as the term is used herein, refers to the particular type and frequency of certain service activities, dictated by the specifications provided by the user. For example, if a user specifies that a machine may operate in salty air conditions, the machine may require frequent washing to prevent rust. Alternatively, if a user specifies that a machine operate in dusty or dirty air conditions, weekly air filter inspections and/or filter replacement may be required. In another example, if a user specifies that a machine may operate on a steep incline for prolonged periods, machine customization system may determine that certain machine weight-bearing components such as, for example, an axel, may require replacement more frequently than normal. As explained, the service requirements may be based on maintenance schedules and lifecycle data derived from historical and/or prognostic data. Additionally, service requirements may include standard (i.e., scheduled) service or maintenance that may not be affected by the user-defined specifications such as, for example, oil changes, safety inspections, etc.

Upon determining the service requirements for the stock machine, machine customization system 140 may estimate a service schedule and service costs (Step 432). The service schedule may be estimated using historical and/or prognostic data stored in prognostic system 131. Service costs may be estimated or derived based on the service requirements and estimated service schedule. These costs may be estimated using standard market pricing for parts and service.

Once the service costs have been determined, machine customization system may estimate the operating costs associated with the stock machine (Step 433). Operating costs may include service costs, as well as other costs associated with operating the machine such as fuel costs and any costs associated with modifying the project environment to accommodate the stock machine (e.g., pumping out marshy land to facilitate the use of stock tires). Certain operating costs may be derived from prognostic and/or historical operation data. For instance, fuel costs may be estimated based on historical fuel economy data. Thos skilled in the art will recognize that fuel consumption may be affected by several factors, including modifications that may be made to the machine to accommodate certain environmental conditions and/or operating a machine in a manner inconsistent with the designed specifications. For instance, operating an unmodified machine on an incline may decrease the average fuel economy when compared to operating a machine modified to accommodate the incline.

In addition to determining the service requirements, estimating the service costs, and predicting the operating costs for the stock machine, machine customization may, in a similar fashion, predict operating costs associated with the customized machine. For instance, machine customization system 140 may identify one or more customization options to modify and/or upgrade the stock machine to more appropriately conform to the user-supplied specifications (Step 435). For example, machine customization system 140 may determine, based on the prognostic data, that a stock machine operating for prolonged periods on an incline may require service twice as frequently than when the same type of machine is operated on level ground. Accordingly, machine customization system 140 may identify and/or select particular component upgrades for the stock machine which may reduce wear due to the inclined terrain of the particular project environment specified by the user.

Once the customized machine conforming to one or more specialized project specifications has been identified, the service requirements may be determined, based on the historic operation and/or prognostic data associated with the particular upgrades. As with the stock machine, a service schedule associated with the service requirements may be established and service costs may be estimated (Step 436), from which operating costs associated with the customized machine may be predicted (Step 437).

Upon determining operating costs associated with the stock machine and the customized machine, machine customization system 140 may generate a cost report (Step 440). The cost report may summarize the cost analysis performed for each of the stock machine and the customized machine, including summaries of the service and operating costs corresponding to each machine. According to one embodiment, cost report may identify potential problematic components associated with the stock machine based on the specifications, and service requirements and cost summaries corresponding to these components. Similarly, the cost report may identify certain component upgrades, including any costs associated with the upgrade, as well as service requirements and service costs associated with the upgrade. As a result, users may easily identify the costs associated with the particular upgrade and any performance benefits (e.g., increased durability, decreased service frequency and/or cost, etc.) that may be attributed to these upgrades.

Optionally, once the cost report has been provided by machine customization system 140, the stock and customized operating costs may be compared (Step 450). Based on the comparison, machine customization system 140 may provide equipment selection recommendations to the user. For instance, if the stock operating costs do not exceed the customized operating costs (Step 450: No), machine customization system 140 may recommend operating the stock machine (Step 460). Alternatively, if the stock operating costs exceed the customized operating costs (Step 450: Yes), machine customization system 140 may recommend employing the customized machine (Step 470).

### INDUSTRIAL APPLICABILITY

Methods and systems associated with the disclosed embodiments provide a cost analysis solution where prognostic data is leveraged to enable users to evaluate the specific costs and benefits associated with customizing a machine. Processes and elements described herein provide users with an interactive system adapted to determine which upgrade options may increase reliability by reducing component wear attributed to operating the machine in abnormal conditions. These upgrades may be evaluated with respect to simply operating an “off-the-shelf” (i.e., stock) component or machine, and a report may be provided to the user. This report may include objective cost-based machine recommendations, enabling users to select optional upgrades based on the potential cost and benefit provided by these upgrades.

Although the disclosed embodiments are described in association with a machine selection process, the disclosed system and method for analyzing customization costs may generally be applicable to any process involving the selection of options or upgrades associated with goods and services. Specifically, the disclosed customization cost analysis system may identify a stock machine based on machine and/or project specification provided by the user, and analyze costs associated with operating the stock machine versus operating a machine tailored to the specifications provided by the user.

The presently disclosed system and method for evaluating machine customization costs may have several advantages. First, in addition to providing users with a means for identifying certain customization options that may increase machine reliability, machine customization system 140 may allow users to evaluate modification, maintenance, and operating costs associated with these options with respect to costs associated with the stock machine. The presently disclosed customization cost evaluation system may allow users to “opt-out” of certain upgrades that do not provide cost benefits when compared to corresponding stock features.

Additionally, the presently disclosed evaluation system may have significant cost benefits when compared with conventional systems that select machine based exclusively on reliability. For example, because machine customization system 140 evaluates costs and benefits associated with an optional upgrade based on custom specification data provided by the user, unnecessary investment in expensive upgrades that may only nominally increase machine reliability may be avoided, potentially resulting in significant cost savings over the lifespan of a machine.

It will be apparent to those skilled in the art that various modifications and variations can be made to the disclosed system and method for analyzing machine customization costs. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for analyzing machine customization costs comprising:
receiving one or more specifications associated with a machine;
identifying a machine type based on the one or more specifications;
analyzing prognostic data associated with the machine type based on the specifications;
estimating costs associated with operating a stock machine corresponding to the machine type based on the analysis;
assembling a machine customization package based on the specifications;
estimating costs associated with operating a customized machine associated with the machine customization package; and
providing a cost analysis report comparing estimated costs associated with operating the stock machine with estimated costs associated with operating the customized machine.

2. The method of claim 1, wherein the prognostic data is derived from health data associated with one or more components of the machine, the health data including one or more of historic health data or expected lifecycle data associated with the components.

3. The method of claim 2, wherein estimating the costs associated with operating the stock machine includes:
predicting, based on the prognostic data and the one or more specifications, an actual lifecycle associated with one or more stock components;
establishing a maintenance schedule that includes one or more maintenance intervals corresponding to the lifecycle associated with the one or more stock components; and
wherein the costs associated with operating the stock machine including costs associated with servicing the one or more stock components during each of the maintenance intervals.

4. The method of claim 3, wherein assembling the machine customization package includes;
identifying, based on the prognostic data, one or more stock components in which the actual lifecycle is shorter than the expected lifecycle; and
providing one or more machine customization packages, each machine customization package substituting a customized component for an identified stock component whose actual lifecycle is shorter than the expected lifecycle.

5. The method of claim 4, wherein estimating the costs associated with operating a customized machine includes:
predicting, based on the prognostic data and the one or more specifications, an actual lifecycle associated with one or more of the customized machine components;
establishing a maintenance schedule that includes one or more maintenance intervals corresponding to the actual lifecycle associated with the one or more customized components; and
wherein the costs associated with operating the customized machine including costs associated with servicing the one or more customized components during each of the maintenance intervals.

6. The method of claim 1, wherein providing the cost analysis report includes providing recommendations for machine selection based on the estimated operating costs of the stock machine and the customized machine.

7. The method of claim 6, wherein the recommendations include:
recommending the customized machine if the estimated stock operating costs exceed the estimated customized operating costs; and
recommending the stock machine if the estimated stock operating costs do not exceed the estimated customized operating costs.

8. The method of claim 1, wherein the specifications include one or more work site characteristics, machine requirements, or task requirements provided by a user.

9. The method of claim 1, wherein the specifications include one or more of temperature, pressure, air quality index, soil quality, angle of inclination, hours of machine operation, or expected payload requirements.

10. A computer-readable medium for use on a computer system, the computer-readable medium having computer executable instructions for performing the method of claim 1.

11. A method for analyzing machine customization costs comprising:
receiving one or more specifications associated with a machine;
analyzing prognostic data associated with the machine based on the specifications;
estimating costs associated with operating a stock machine corresponding to the machine type based on the analysis;
assembling a machine customization package based on the specifications;
estimating costs associated with operating a customized machine associated with the machine customization package;
selecting the customized machine if the estimated stock operating costs exceed the estimated customized operating costs; and
selecting the stock machine if the estimated stock operating costs do not exceed the estimated customized operating costs.

12. The method of claim 11, wherein the prognostic data is derived from health data associated with one or more components of the machine, the health data including one or more of historic health data associated with the components or expected lifecycle data associated with the components.

13. The method of claim 12, wherein the prognostic data is derived from health data associated with one or more stock components of the machine and estimating the costs associated with operating the stock machine includes:
predicting, based on the prognostic data and the one or more specifications, an actual lifecycle associated with one or more stock components;
establishing a maintenance schedule that includes one or more maintenance intervals corresponding to the lifecycle associated with the one or more stock components; and
wherein the costs associated with operating the stock machine including costs associated with servicing the one or more stock components during each of the maintenance intervals.

14. The method of claim 13, wherein assembling the machine customization package includes;
identifying, based on the prognostic data, one or more stock components in which the actual lifecycle is shorter than the expected lifecycle; and
providing one or more machine customization packages, each machine customization package substituting a customized component for an identified stock component whose actual lifecycle is shorter than the expected lifecycle.

15. The method of claim 14, wherein estimating the costs associated with operating a customized machine includes:
predicting, based on the prognostic data and the one or more specifications, an actual lifecycle associated with one or more of the customized machine components;
establishing a maintenance schedule that includes one or more maintenance intervals corresponding to the actual lifecycle associated with the one or more customized components; and
wherein the costs associated with operating the customized machine including costs associated with servicing the one or more customized components during each of the maintenance intervals.

16. The method of claim 11, further including providing a cost analysis report that includes a comparison of the estimated costs associated with operating the stock machine with estimated costs associated with operating the customized machine.

17. The method of claim 11, wherein the specifications include one or more work site characteristics, machine requirements, or task requirements provided by a user.

18. The method of claim 11, wherein the specifications include one or more of temperature, pressure, air quality index, soil quality, angle of inclination, hours of machine operation, or expected payload requirements.

19. A system for evaluating machine customization costs comprising:
a data collector for collecting health data associated with a machine;
a prognostic analysis system, communicatively coupled to the data collector, and configured to:
receive the health data from the data collector; and
derive prognostic data for a plurality of machine types and components associated therewith, based on the health data;
a machine customization system in communication with the data collector and configured to:
receive one or more specifications associated with the machine;
identify a machine type based on the one or more specifications;
analyze prognostic data associated with the machine type based on the specifications;
estimate costs associated with operating a stock machine corresponding to the machine type based on the analysis;
assemble a machine customization package based on the specifications;
estimate costs associated with operating a customized machine associated with the machine customization package; and
provide a cost analysis report comparing estimated costs associated with operating the stock machine with estimated costs associated with operating the customized machine.

20. The system of claim 19, wherein estimating the costs associated with operating the stock machine includes:
predicting, based on the prognostic data and the one or more specifications, an actual lifecycle associated with one or more stock components;
establishing a maintenance schedule that includes one or more maintenance intervals corresponding to the lifecycle associated with the one or more stock components, wherein the costs associated with operating the stock machine including costs associated with servicing the one or more stock components during each of the maintenance intervals; and wherein assembling the machine customization package further includes:
identifying, based on the prognostic data, one or more stock components in which the actual lifecycle is shorter than the expected lifecycle; and
providing one or more machine customization packages, each machine customization package substituting a customized component for an identified stock component whose actual lifecycle is shorter than the expected lifecycle.
